(19) United States
(12) Patent Application Publication
(10) Pub. No.: US 2006/0285836 A1
(43) Pub. Date: Dec. 21, 2006

(54) Inflatable photographic structure

(76) Inventor: Roman Coppola, Hollywood, CA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 10/568,656

(22) PCT Filed: Aug. 18, 2004
(86) PCT No.: PCT/US04/27360

§ 371 Date: Feb. 15, 2006

Related U.S. Application Data
(60) Provisional application No. 60/497,236, filed on Aug. 21, 2003.

(51) Int. Cl. G03B 15/00

(52) U.S. Cl. 396/1

(57) ABSTRACT

The present invention is directed toward a photographic system (100) wherein a subject (240) is photographed from within a translucent bubble (110) lit by light (120) from outside the bubble. The bubble is adapted to provide a uniform background which can be digitally replaced after photographing.

This application claims the benefit of U.S. provisional application No. 60/497236 filed on Aug. 21, 2003 incorporated herein by reference in its entirety.

### FIELD OF THE INVENTION

The field of the invention is photography.

### BACKGROUND OF THE INVENTION

For both still and motion photography, it is desirable to be able to photograph a subject in a studio yet have a background that makes the subject appear to have been photographed in another setting. This can be accomplished, particularly with still photography, by projecting an image onto a screen behind the subject before photographing. For motion photography, on the other hand, the background is generally replaced after photographing.

The process of replacing the background after photographing is referred to as chroma replacement or “blue screen” or “green screen” because it involves photographing a subject in front of a solid color (e.g. blue or green) background then replacing the color with a new background. In a chroma replacement process, the subject is digitally separated from the background before replacing the background with a digital representation of a new background.

Methods of background replacement which utilize projection, particularly front projection, have inherent problems related to shadowing. Shadowing typically occurs because of misalignment between the projection beam and the camera lens. U.S. Pat. No. 5,946,500 issued in August of 1999 to Oles addresses the problem of shadowing caused by misalignment. The '500 patent teaches precise and automatic alignment of the background projection beam with the center of the camera lens. Because the projection beam is aligned with the center of the camera lens, fringe shadowing is substantially reduced.

Shadowing can also occur while lighting the subject being photographed. Various items have been used with a modicum of success to control shadowing caused by stage lighting, among them light blockers, light intensity reducers, and light diffusers. Despite use of these items, problems with shadowing persisted. Some of these problems have been addressed by backlighting which is basically lighting a subject from behind the subject itself (i.e. not from the “camera side” of the subject). Still, backlighting has specific disadvantages among them the lack of sufficient light on the front of the subject and the excessive amount of light being directed toward the lens of the camera.

In order to diffuse the light that reaches the camera and to cause less shadowing, U.S. Pat. No. 6,343,184 to Huebner in January 2002 teaches that a subject can be photographed from within a translucent enclosure that is illuminated using externally located lights. Huebner further teaches that the subject is photographed with a camera mounted on the enclosure. The subject is suspended inside the enclosure and the enclosure (and the camera) rotate about the subject so that photos can be taken from various angles. The teachings of the '184 patent work relatively well to reduce shadowing as well as to provide a uniform backdrop for chroma replacement. The enclosure described by Huebner, however, is virtually useless for photographing a large subject (e.g. a car) or for motion photography, particularly because the subject being photographed must be suspended as the enclosure rotates about it.

Thus, there is a need for methods and devices that can be used for both still, photography and motion photography without the inherent problems described above.

### SUMMARY OF THE INVENTION

In accordance with the present invention, an improved photographic system is provided. The photographic system comprises a sufficiently translucent inflatable structure that is adapted to provide a uniform background. Visible light waves from outside the structure enter the structure in order to illuminate the inside of the structure. More particularly, the subject being photographed and/or an interior surface of the structure (a wall of the structure) may be illuminated with the light that enters the structure.,

In another aspect, a photographic method includes the steps of providing an inflatable structure having a uniform background, photographing a subject located inside the inflatable structure, and lighting the inside of the structure with visible light waves emanating from outside the structure.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is an exterior view of a photographic system.

FIG. 2 is an interior view of a photographic system.

FIG. 3 is an exterior view of an alternative photographic system.

FIG. 4 is a block diagram of a photographic method.

### DETAILED DESCRIPTION

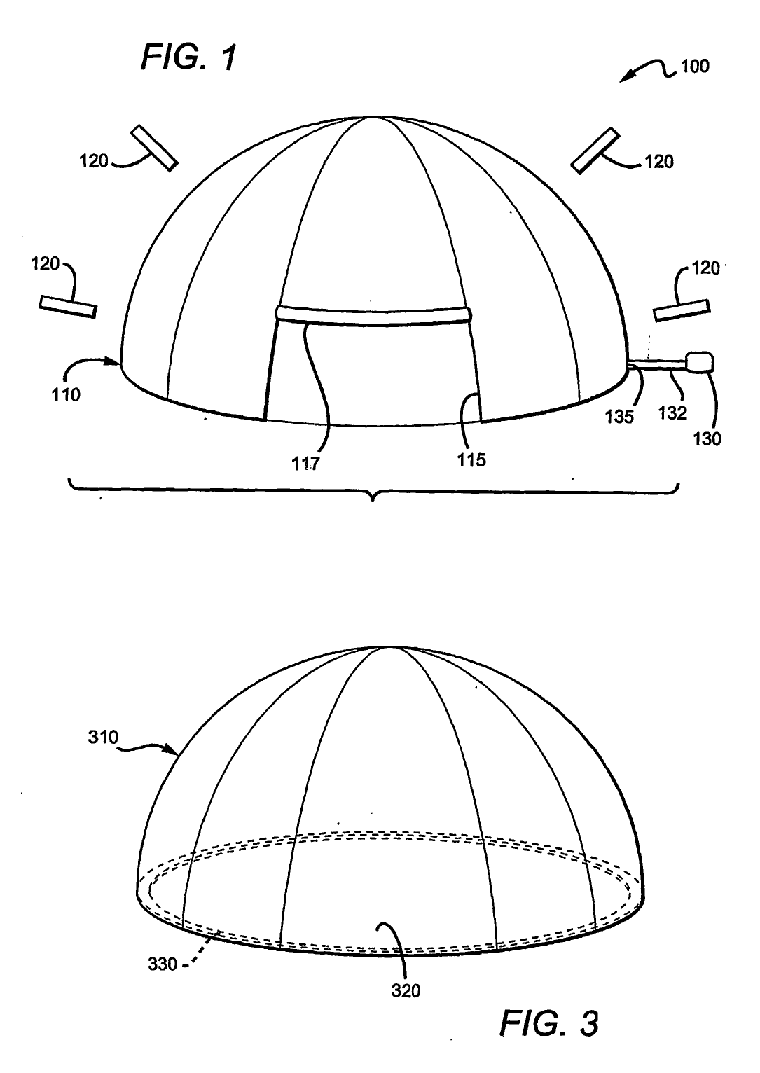

Referring first to FIG. 1, a photographic system 100 generally includes an inflatable structure 110, light sources 120, and an inflation device 130.

Inflatable structure 110 is substantially comprised of 6 mm vinyl sheeting. While vinyl sheeting is the preferred constituent material for an inflatable structure, it will be understood by one of skill in the art that other materials will suffice so long as they are capable of being inflated, are sufficiently translucent, and are capable of being adapted to provide a uniform background. Other contemplated constituent materials that can be used for the inflatable structure include various plastics, paper, cotton, nylon, and polyester, and light weight rubber. Poly-silk is preferred for its durability and nylon works particularly well because it is light weight. Because the structure is likely to be comprised of a light weight flexible material, the structure is envisaged to be easily transportable.

Structure 110 is sufficiently translucent such that visible light waves from outside the structure are transmitted into the structure. In a particular class of embodiments, the entire structure, particularly the ceiling, is made of a soft translucent material. There are various ways of measuring the translucency of a material such as by “diffuse transmission.” or “through translucency”, but regardless of the method used to measure translucency, sufficient translucency depends upon whether enough visible light is transmitted into the structure so that the subject of the photography is illuminated to the desired extent (i.e. to the desired extent of the photographers or others involved in the photography of the subject). It is, important to recognize that diffused light is desirable for photographing a subject because it casts a softer shadow than light which has not been diffused. Another factor affecting whether a structure is sufficiently translucent is the degree of lighting that comes from an internal lighting source—the more internal lighting, the less translucent the structure needs to be.

The word “photograph”, and its derivatives, should be interpreted herein as broadly as possible while remaining with the overall inventive concept. Thus, a subject being photographed includes a person or object being filmed, taped, or otherwise captured on media, digitally or not, in motion or still.

While the size of an inflatable structure can vary significantly, it is preferred that an inflatable structure be large enough to allow people, props, booms, cameras and other stage equipment to all be inside the structure at one time. It is contemplated that an inflatable structure can have a horizontal length (or a diameter) of 200 feet or more and a height of 35 feet or more. It can be observed that inflatable structure 110 is dome shaped (i.e. half spherical or hemispherical), however other shapes are suitable including cylindrical, and even some having angles (e.g. a geodesic dome shape). In a particularly preferred class of embodiments, the inflatable structure surrounds the subject being photographed so that the background is present no matter which angle the subject is photographed from. An inflatable structure is preferred to be fully coved (i.e. no hard edges) and to have few seams and few panels. Fewer seams and panels are advantageous because seams formed from the coupling of panels tend to detract from the uniformity of the background. In some embodiments, there are only seams at the openings to the structure.

The inside surface of the inflatable structure is adapted to provide a uniform background for photographing a subject. A uniform background is a background that is susceptible to being replaced—typically by a chroma replacement method. It is preferred that a uniform background have relatively little color variation and texture variation over the entire surface of the background. In adapting an inflatable structure to provide a uniform background, the background (i.e. inside surface of the inflatable structure) can be painted or otherwise colored so that the color is substantially the same over the entire surface of the background. The color used for the background can be a chroma key color (e.g. blue or green) or another color so long as that color is suitable for use in a background replacement method. The inside surface of the background may be black in order to simulate an evening sky. In another exemplary configuration, a day sky can be painted or projected onto the background. In addition, the back ground can be re-textured so that the surface texture is substantially the same over the entire surface of the background. As pointed out above, seams detract from the uniformity of the background and therefore fewer seams are preferred especially in areas that are likely to be captured by the camera.

Inflatable structure 110 has an entrance 115 which enables people, props, photography equipment, and so on to enter the structure. The structure 110 also has an entrance 135 for air from the inflation device 130 to enter the structure. In a preferred class of inflatable structure, there are only two entrances, however, less preferred embodiments have more than two entrances and may have additional entrances for overhead equipment. Since structure 110 is inflatable, entrances should be as small as possible yet large enough to allow entry of people, props, equipment, and so forth to enter the structure. An entrance can also be configured so that it may be closed from ambient air when not in use. However, as long as air flow entering the structure is greater than that exiting, large openings are able to remain open. The existence of large openings facilitates transportability of equipment into and out of the structure.

Entrance 115, for example, has a supply of material 117 that is rolled up and secured when the entrance is being used, but is unrolled when the entrance is not being used to prevent loss of air. Other types of openings can be incorporated including those that can be substantially resealed using zippers, snaps, and other known means of coupling. The more preferred means of coupling are those that do not detract from the uniformity of the background. It will be understood by one of ordinary skill in the art that air loss is not a significant issue because of the relative ease of adding additional sources of air (e.g. fans).

Inflation device 130 is an electric air pump that has a hose 132 through which air is pumped into the inflatable structure at entrance 135. The power (e.g. amplitude, horsepower) of the inflation device should be sufficient to keep the structure pressurized so that it does not collapse or even waver despite one or more entrance being open. It should be noted that movement or wavering of the structure is likely to deter from the uniformity of the background and therefore is to be avoided.

Light sources 120 (e.g. stage lighting), located outside of the structure, provide visible light waves that are transmitted into the structure in order to illuminate the subject being photographed. An advantage of locating light sources and other equipment outside the structure is that the equipment is out of view and therefore will not reflect onto any subject being photographed. It should be added that a structure can be used to make controlled reflections. This can be accomplished by “blacking out” the interior walls of the structure so that these reflections can be controlled.

The quantity, location, and power of the light sources as well as the transparency of the structure are factors that will contribute to the amount of light cast upon the subject being photographed. In addition, the amount of ambient light outside the structure is another factor, and in fact, at times ambient light by itself can be sufficient to illuminate the subject inside the structure. It should be noted that light sources may, at times, be located inside the structure so that a particular lighting effect can be achieved.

A further advantageous aspect of the inventive subject matter is that large areas of soft light can be achieved at a low cost and in a flexible manner. This is done by using an inflatable structure outside thereby allowing diffused ambient light from the sun to enter the structure thereby creating a “soft box” affect.

Light from outside the structure can be used to illuminate a subject being photographed, a portion of the structure itself, or both. In some cases, the visible light waves that enter the structure will be colored. This colored light (as opposed to white light) may come from a coherent light source or even from use of a colored filter. In other cases the visible light waves that enter the structure may be incoherent (mixed frequencies) although such light may be used to illuminate a colored material (e.g. on the interior surface of the structure wall).

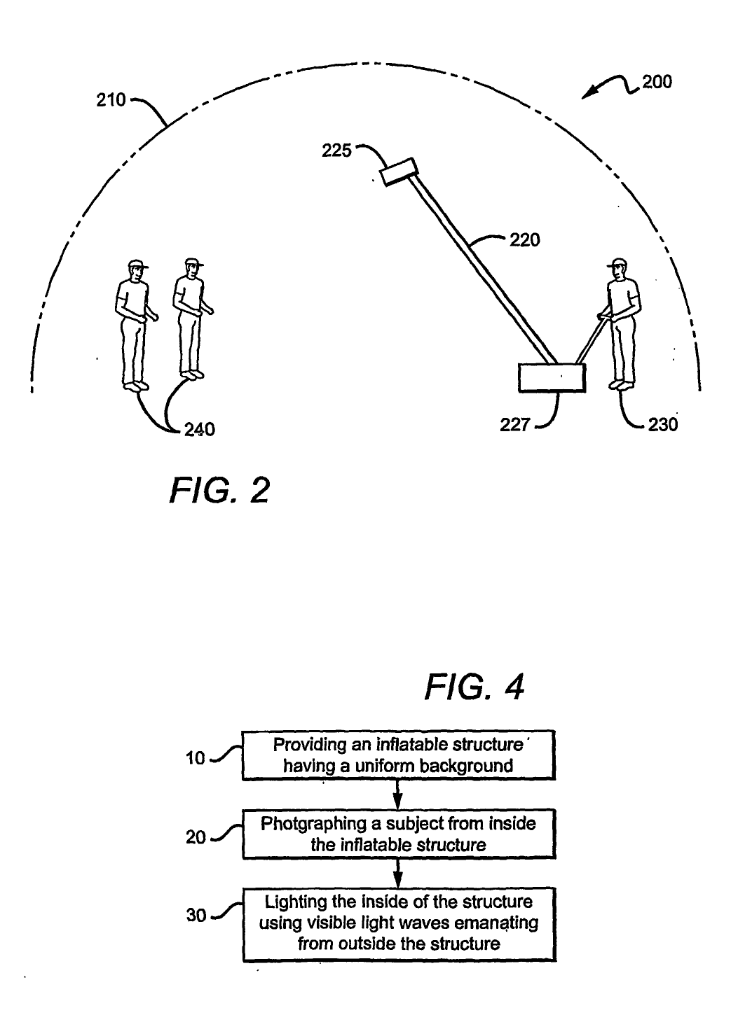

FIG. 2 is an interior view of a photographic system 200. Structure 210 is shown using a dotted line, because, from an interior view, the form of the structure is not readily discernable. FIG. 2 also depicts a boom 220 from which a camera 225 is extended. Boom 220 allows the camera or other piece of equipment to be positioned at various angles relative to the subject being photographed. Boom 220 is coupled to a base 227 that can travel on tracks that are setup on the ground inside the structure. By setting up a boom to travel on tracks, movement of the equipment can be done quickly. On the other hand, a camera or other piece of equipment can be handheld and transported solely by movement of the operator.

Camera operator 230 is located inside the structure 210, and from that location, the camera operator 230 controls camera 225. Camera 225 can also be partially or completely operated from a remote location (i.e. outside of the structure), for example, using 802.11 or Bluetooth® technologies.

In FIG. 2, the subject being photographed is the actors 240. It should be understood that a subject can be a person, an object, or a combination of both, and in addition, the subject can be moving or still. In addition, a portion of the background or setting can actually be physically located within the structure.

In FIG. 3, it can be observed that an inflatable structure 310 is held to the floor 320 using an annular channel 330. A channel is preferred to contain a material that adds weight (e.g. water or sand) to the structure so that a relatively air tight seal is formed between the channel and floor. A relatively air tight seal between the structure and the ground can be accomplished in other ways. For instance, the perimeter of the structure can be adhesively coupled to the floor. In some embodiments, the floor 320 is an integral part of the inflatable structure. That is, the floor is an extension of the side walls of the structure. In embodiments where the floor is an integral part of the structure, additional flooring members (e.g. plywood panels) may be placed over the floor in order to provide a stable level surface and in order to hold the structure down. Additionally, the floor can also be adapted to provide additional uniform background for the subject of the photography.

FIG. 4 is a block diagram of a photographic method. The method comprises the steps of: 10 providing an inflatable structure having a uniform background; 20 photographing a subject from inside the structure; and 30 lighting the inside of the structure with visible light waves emanating from outside the structure.

The step of providing an inflatable structure having a uniform background generally includes configuring the structure so that the inside walls of the structure can be used as a background that will be digitally replaced. In configuring the structure to be used as a background, it may be desirable to paint or otherwise color the background so as to provide uniformity in color.

Another aspect of providing an inflatable structure is the process of manufacturing a structure large enough to accommodate actors, technicians, and equipment. The difficulty in manufacturing such a large structure is that very large pieces of material are desired since the structure should be made with as few seams as possible.

The step of photographing a subject from inside the structure generally includes utilizing a freely movable camera. Freely movable means that the camera is able to be used at various angles relative to the subject being photographed without movement of the structure or the frame of the structure. Thus, a step of photographing a subject may further include a step of locating a boom relative to the subject. Photographing a subject from inside the structure means that the camera lens and the subject are both located inside the structure. While it is preferred that the camera is operated by a camera operator located inside the structure, some less preferred embodiments allow for the camera to be operated by an operator located outside of the structure. It is important to note that the size of the structure is envisaged to be large enough to accommodate multiple cameras of the size commonly used for filming motion pictures.

With regard to the step of lighting the inside of the structure with visible light waves emanating from outside the structure, this step more particularly includes lighting the subject to be photographed. On certain occasions, it may be advantageous to light the inside of the structure with relatively more light than on other occasions. In fact, the step of lighting the structure may not be an affirmative step at all since ambient light may enter the structure in an amount sufficient to light the subject being photographed.

Thus, specific embodiments and applications of an inflatable cinematographic structure have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A photographic system, comprising:
an inflatable structure adapted to provide a uniform background for photographing a subject inside the structure, wherein the structure is sufficiently translucent such that visible light waves from outside the structure are transmitted into the structure in order to illuminate the inside of the structure.

2. The system of claim 1, wherein the visible light waves are colored.

3. The system of claim 1, wherein the visible light waves illuminate a colored material.

4. The system of claim 1, wherein at least a portion of the visible light waves transmitted into the structure emanate from stage lighting located outside of the structure.

5. The system of claim 1, wherein the visible light waves transmitted into the structure are substantially comprised of ambient light.

6. The system of claim 1, wherein the inflatable structure is comprised of a plastic sheeting.

7. The system of claim 6, wherein the plastic sheeting is a vinyl.

8. The system of claim 7, wherein the vinyl has a thickness of at least 4 mm.

9. The system of claim 1, wherein the inflatable structure has a floor area of more than 20,000 sq. ft.

10. The system of claim 1, wherein the uniform background is substantially colored a chroma key color.

11. The system of claim 10, wherein the chroma key color is blue.

12. The system of claim 10, wherein the chroma key color is green.

13. The system of claim 1, wherein the inflatable structure has a 10 ft×10 ft. entrance.

14. The system of claim 1, wherein the subject is an actor.

15. The system of claim 1, wherein the subject is a car.

16. The system of claim 1, wherein the subject is photographed with a camera located within the structure.

17. The system of claim 16, wherein the camera is controlled from within the structure.

18. The system of claim 16, wherein the camera is capable of moving independent of the structure.

19. The system of claim 16, wherein the camera is operated by a camera operator located within the structure.

20. A photographic method, comprising:
providing an inflatable structure having a uniform background;
photographing a subject inside the inflatable structure; and
lighting the inside of the structure with visible light waves emanating from outside the structure.

21. The method of claim 20, wherein the step of photographing a subject further comprises filming a subject against the uniform background.

22. The method of claim 20, wherein the step of lighting the inside of the structure further comprises setting up stage lighting outside of the structure.

23. The method of claim 20, further comprising the step of painting the uniform background with a chroma key color.
